(19) United States
(12) Patent Application Publication
(10) Pub. No.: US 2007/0216167 A1
(43) Pub. Date: Sep. 20, 2007

(54) Adjustable latch assembly

(75) Inventor: Wen-Pin Wu, Kaohsiung Hsien (TW)

Correspondence Address: BIRCH STEWART KOLASCH & BIRCH, PO BOX 747, FALLS CHURCH, VA, 22040-0747, US

(73) Assignee: Taiwan Fu Hsing Industrial Co., Ltd., Kaohsiung Hsien (TW)

(21) Appl. No.: 11/724,193

(22) Filed: Mar. 15, 2007

Related U.S. Application Data
(63) Continuation-in-part of application No. 10/854,277, filed on May 27, 2004, now abandoned.

(51) Int. Cl. E05C 1/00

(52) U.S. Cl. 292/1.5

(57) ABSTRACT

An adjustable latch assembly includes a cylindrical housing to accommodate a deadbolt which has a first notch and a second notch. Correspondingly, each of the assembling plates has an assembling hole and an adjusting groove. Two assembling plates are inserted into an adjustable casing which includes an axial hole, a pair of assembling holes and a passage. A pulling member is sandwiched in between the two assembling plates, and has an engaging gap in which to extend an engaging arm of an actuating cam. A push-button member is movably received in the passage of the adjustable casing, and has an inclined surface. In adjusting operation, the inclined surface of the push-button member moves upward a bottom edge of the pulling member so that a shoulder of the pulling member is disengaged from either of the first notch or the second notch of the connecting plate.

### CROSS REFERENCE TO RELATED APPLICATION

This application is a Continuation-In-Part application of U.S. patent application Ser. No. 10/854,277, filed on May 27, 2004.

### BACKGROUND OF THE INVENTION

1. Field of the Invention

The present invention relates to an adjustable latch assembly which has an adjustable device and a simplified structure for adjusting an assembling distance.

2. Description of the Related Art

Referring initially to FIG. 7, applicant's own Taiwanese Pat. Publication No. 147,136, titled “AUXILIARY LOCK WITH AN EXTENSIBLE DEVICE,” corresponding to U.S. Pat. No. 4,957,315 discloses a latch assembly including a cylindrical housing 90 contained a deadbolt 91. A bottom portion of the cylindrical housing 90 connects with a pair of assembling plates 92 on which to sleeve a casing 93. An actuating cam 94 is sandwiched in between the two assembling plates 92 (identified as first assembling plate 92a and second assembling plate 92b), and is connected with a pulling member 95 through an adapter 98 for synchronous movement. The pulling member 95 further includes a shoulder portion 951 adapted to selectively engage with one of a first notch 961 and a second notch 962 of a connecting plate 96. An end of the connecting plate 96 pivot-connects with a bottom portion of the deadbolt 91.

To accomplish a pivotal movement between the actuating cam 94 and the pulling member 95, there must provides an elongated slot 941 of the actuating cam 94 in which to receive a movable pin 981 of the adapter 98. Also, there further provides a through hole 953 of the pulling member 95 in which to receive another pin 982 of the adapter 98. Accordingly, this may complicate the entire structure and the manufacture cost of the actuating cam 94 and the pulling member 95. Again, additional processes for manufacturing the actuating cam 94 and the pulling member 95 are wasteful of material in mass production.

The connecting plate 96 further includes an elastic member 963 to provide a downward bias force exerting on the pulling member 95 such that an upward movement of the pulling member 95 can be returned in an adjusting operation of an assembling distance of the latch assembly. The pulling member 95 is further formed with a positioning lug 954 to engage with an end of the elastic member 963.

The first assembling plate 92a is formed with an assembling hole 920 in which a separating wall 921 (shown at the shadow region in FIG. 7) is provided. The separating wall 921 is extended inwardly and downward from a top edge of the assembling hole 920. The separating wall 921 defines an operating slot 922 on a side edge of the assembling hole 920, and further defines a horizontal passageway 923 on a bottom edge of the assembling hole 920. The horizontal passageway 923 connects with a bottom portion of the operating slot 922.

In adjusting operation, a push-button member 97 is employed to initially disengage the pulling member 95 from the connecting plate 96. The push-button member 97 has an inclined wall 971 which is engaged with a bottom edge 952 of the pulling member 95. When the push-button member 97 is pushed, the inclined wall 971 of the push-button member 97 may move the bottom edge 952 of the pulling member 95 upward. After pushing the push-button member 97 a predetermined distance, the shoulder portion 951 of the pulling member 95 may be disengaged from either of the first notch 961 or the second notch 962 of the connecting plate 96. Consequently, the disengagement permits adjusting an assembling distance of the latch assembly.

The inclined wall 971 of the push-button member 97 is of a thin-wall construction, and is slidably received within the operating slot 922 of the assembling hole 920 to permit access to the bottom edge 952 of the pulling member 95. Once the shoulder portion 951 of the pulling member 95 is disengaged from the first notch 961 of the connecting plate 96, there is a need for using a tool member (i.e. pin) to maintain the disengagement of the shoulder portion 951 of the pulling member 95 for allowing a free movement of the pulling member 95. After that, the push-button member 97 is released to completely withdraw the inclined wall 971 from the operating slot 922 of the assembling hole 920 so as to permit a rod portion 972 of the push-button member 97 is located in the horizontal passageway 922 of the assembling hole 920. Accordingly, this permits operating a longitudinal movement of the push-button member 97 along the horizontal passageway 922 of the assembling hole 920 in adjusting the assembling distance of the latch assembly. In this manner, the separating wall 921 of the first assembling plate 92a does not obstruct the inclined wall 971 of the push-button member 97 which has been completely withdrawn from the operating slot 922 of the assembling hole 920.

However, the latch assembly employs the adapter 98 to connect the actuating cam 94 with the pulling member 95 that may complicate the entire structure and manufacture process of the latch assembly. Also, the complicated structure of the latch assembly may result in an increase of manufacture cost. Furthermore, the adapter 98 connected between the actuating cam 94 and the pulling member 95 is protruded from a top portion of the casing 93 that may cause the latch assembly to increase its dimensions. Consequently, the increased dimensions of the latch assembly may result in an inconvenience for assembling on a doorplate where an installation space may be limited. Also, the latch assembly may be unsuitable for some particular specification of the doorplate.

In addition to this, the problem occurring during use of the first assembling plate 92a is due to the fact that the separating wall 921 formed in the assembling hole 920 may obstruct the inclined wall 971 of the push-button member 97 if it is not completely withdrawn from the operating slot 922 of the assembling hole 920, as best shown in FIG. 8. There is a design limitation existing for this type of the first assembling plate 92a due to the structure design of the separating wall 921. Yet, another problem with the operation of the pulling member 95 is the difficulty in maintaining the disengagement of the shoulder portion 951 of the pulling member 95 from one of the first notch 961 and the second notch 962 of the connecting plate 96. The adjusting operation of the latch assembly may fail, if any unexpected loose of the tool member (not shown) occurs.

### SUMMARY OF THE INVENTION

The primary objective of this invention is to provide an adjustable latch assembly which can conveniently adjust an assembling distance, and simplify the entire structure for speeding manufacture time and reducing manufacture cost.

The adjustable latch assembly in accordance with the present invention includes a cylindrical housing having a first end and a second end. The first end of the cylindrical housing connects a faceplate while the second end forming a connecting slot. Two assembling plates are arranged in parallel and mechanically mounted in the connecting slot. The cylindrical housing accommodates a deadbolt connecting with a connecting plate which has a first notch and a second notch. Correspondingly, each of the assembling plates has an assembling hole and an adjusting groove. The two assembling plates are inserted into an adjustable casing which includes an axial hole, a pair of assembling holes and a passage. A pulling member is sandwiched in between the two assembling plates, and has an engaging gap in which to extend an engaging arm of an actuating cam. A push-button member is movably received in the passage of the adjustable casing, and has a pushing rod and an inclined surface thereof. In adjusting operation, the inclined surface of the push-button member moves upward a bottom edge of the pulling member so that a shoulder of the pulling member is disengaged from either of the first notch or the second notch of the connecting plate.

In an aspect of the present invention, a pair of bent plates define the engaging gap of the pulling member therebetween.

In a separate aspect of the present invention, the bent plates are integrally formed on the pulling member, and each of the bent plates defines a roughly C-shaped section of the pulling member.

In a further separate aspect of the present invention, the bent plates are integrally formed on a bottom portion of the pulling member.

In a yet further separate aspect of the present invention, the two assembling plates includes a first assembling plate and a second assembling plate, wherein the first assembling plate is formed with an assembling hole in which to provide a first recessed edge and a second recessed edge at a bottom edge.

In a yet further separate aspect of the present invention, the assembling hole includes an upper guiding edge to define a straight line on which to guide a longitudinal movement of the push-button member.

In a yet further separate aspect of the present invention, the upper guiding edge is located on an upper edge opposite to a bottom edge of the assembling hole.

In a yet further separate aspect of the present invention, the first recessed edge and the second recessed edge are spaced apart by a protruded bottom edge.

Further scope of the applicability of the present invention will become apparent from the detailed description given hereinafter. However, it should be understood that the detailed description and specific examples, while indicating preferred embodiments of the invention, are given by way of illustration only, since various changes and modifications within the sprit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is an exploded perspective view of an adjustable latch assembly in accordance with a preferred embodiment of the present invention;

FIG. 2 is a partial cross-sectional view of the adjustable latch assembly in a retracted position in accordance with the preferred embodiment of the present invention;

FIG. 3 is a cross-sectional view, taken along line 3-3 in FIG. 2, of the adjustable latch assembly in accordance with the preferred embodiment of the present invention;

FIG. 4 is a cross-sectional view, similar to that shown in FIG. 3, of the adjustable latch assembly in adjusting operation in accordance with the preferred embodiment of the present invention;

FIG. 5 is a cross-sectional view, similar to that shown in FIG. 2, of the adjustable latch assembly in adjusting operation in accordance with the preferred embodiment of the present invention;

FIG. 6 is a partial cross-sectional view, similar to that shown in FIG. 2, of the adjustable latch assembly in an extended position in accordance with the preferred embodiment of the present invention;

FIG. 7 is an exploded perspective view of a conventional latch assembly in accordance with the prior art, for comparison with FIG. 1; and

FIG. 8 is a fragmental assembled view of the conventional latch assembly in accordance with the prior art depicted in FIG. 7, showing a separating wall of first assembling plate obstructing an inclined wall of push-button member which is pressed into an operating slot of assembling hole.

REFERENCE NUMERAL

| | | | |
|---|---|---|---|
| 1 | cylinder housing | 12 | faceplate |
| 13 | fixing ring | 14 | connecting slot |
| 2 | deadbolt | 21 | groove |
| 22 | connecting plate | 221 | first notch |
| 222 | second notch | 223 | limiting rod |
| 224 | guide rod | 23 | fixing pin |
| 3 | assembling plate | 31 | assembling hole |
| 31a | first assembling hole | 31b | second assembling hole |
| 311 | first recessed edge | 312 | second recessed edge |
| 313 | protruded bottom edge | 314 | upper guiding edge |
| 32 | longitudinal slot | 33 | protrusion |
| 34a | first adjusting groove | 34b | second adjusting groove |
| 35 | numeral mark | | |
| 4 | adjustable casing | 41 | longitudinal slot |
| 42 | axial hole | 43 | assembling hole |
| 44 | passage | 45 | examining hole |
| 5 | pulling member | 51 | shoulder |
| 52 | engaging gap | 521 | first bent plate |
| 522 | second bent plate | | |
| 53 | elastic member | 54 | positioning lug |
| 6 | actuating cam | 60 | flat outer edge |
| 61 | engaging arm | 62 | elastic member |
| 7 | push-button member | 71 | limit member |
| 72 | pushing rod | 73 | inclined surface |
| 74 | coil spring | 75 | protrusion member |

### DETAILED DESCRIPTION OF THE INVENTION

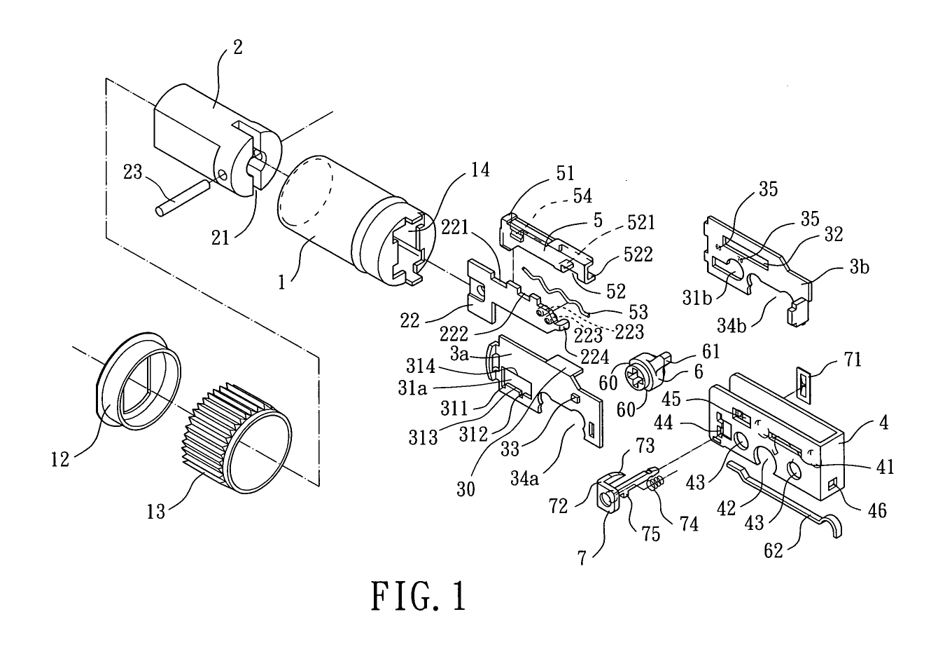

Referring initially to FIG. 1, an adjustable latch assembly in accordance with a preferred embodiment of the present invention includes a cylindrical housing 1, a deadbolt 2, a pair of assembling plate 3, an adjustable casing 4, a pulling member 5, an actuating cam 6 and a push-button member 7.

Referring again to FIG. 1, the cylindrical housing 1 is provided with an opening end at its first end and accommodates the deadbolt 2 which can be slidably extended from the opening end of the cylindrical housing 1. After the cylindrical housing 1 has accommodated the deadbolt 2, the opening end of the cylindrical housing 1 further connects with a faceplate 12 that prevents from removal of the deadbolt 2. Preferably, the faceplate 12 can be selected from a rectangle-shaped or circle-shaped member. The cylindrical housing 1 employs a fixing ring 13 to sleeve its outer surface and to rotatably adjust a predetermined position about an axis line. Thus, the fixing ring 13 can securely mount the cylindrical housing 1 in a positioning hole of a doorplate (not shown). Furthermore, the cylindrical housing 1 further is provided with a connecting slot 14 at its second end. The connecting slot 14 mechanically connects with the assembling plates 3.

The deadbolt 2 is confined within the cylindrical housing 1 to prevent from any unwanted removal. The deadbolt 2 has an end and a groove 21 thereof to connect to a connecting plate 22 by a fixing pin 23. The connecting plate 22 has a first notch 221 and a second notch 222 spaced apart in series.

The assembling plates consist of two plate members (identified as first assembling plate 3a and second assembling plate 3b) arranged in parallel. The first assembling plate 3a and the second assembling plate 3b are mechanically mounted in the connecting slot 14 of the cylindrical housing 1, and the first assembling plates 3a has a first assembling hole 31a and a first adjusting groove 34a while the second assembling plates 3b has a second assembling hole 31b and a second adjusting groove 34b. The first assembling plate 3a of the assembling plates 3 provides a first recessed edge 311 and a second recessed edge 312 in the first assembling hole 31a. The second assembling plate 3b further provides a longitudinal slot 32 adapted to receive a guide rod 224 of the connecting plate 22 so that movements of the connecting plate 22 is limited in the guide slot 32 of the second assembling plates 3b.

Preferably, the first recessed edge 311 and the second recessed edge 312 of the first assembling plate 3a are formed on a bottom edge of the first assembling hole 31a. In this preferred embodiment, the first recessed edge 311 and the second recessed edge 312 are spaced apart by a protruded bottom edge 313. The first recessed edge 311, the protruded bottom edge 313 and the second recessed edge 312 are arranged in series at the bottom edge of the first assembling hole 3a. In a preferred embodiment, the first assembling hole 31a of the first assembling plate 3a includes an upper guiding edge 314 to define a straight line on which to guide a longitudinal movement of the push-button member 7. The upper guiding edge 314 is located on an upper edge opposite to the bottom edge of the first assembling hole 31a.

The adjustable casing 4 is slidably mounted on the two assembling plates 3a and 3b. In order to limit the adjusting movement of the adjustable casing 4 along a predetermined path with respect to the assembling plates 3a and 3b, the adjustable casing 4 is provided with a longitudinal slot 41 to receive a protrusion 33 of the first assembling plate 3a. The adjustable casing 4 further includes an axial hole 42, a pair of assembling holes 43 and a passage 44. In adjusting operation, moving the adjustable casing 4 with respect to the assembling plates 3a and 3b, the axial hole 42 of the adjustable casing 4 exactly aligns with one of two distal ends of the adjusting groove 34. Each of the assembling holes 43 locates at either side of the axial hole 42. To clearly examine the adjusting movement of the adjustable casing 4, the adjustable casing 4 further is provided with an examining hole 45 for displaying numeral marks 35 of the second assembling plate 3b. After moving the adjustable casing 4 with respect to the assembling plates 3a and 3b, the examining hole 45 of the adjustable casing 4 aligns with the corresponding numeral mark 35.

The pulling member 5 has a predetermined length, and is constructed from a one-piece member. The pulling member 5 includes a first end forming a shoulder 51 selectively engaged with one of the first notch 221 or the second notch 222 of the connecting plate 22. And the pulling member 5 includes a second end forming an engaging gap 52 engaged with an engaging arm 61 of the engaging cam 6. To insure the engagement of the pulling member 5 with the connecting plate 22, one end of an elastic member 53 bias a positioning lug 54 of the pulling member 5 while the other end of the elastic member 53 engaging in two limiting rods 223 of the connecting plate 22. Thus, the shoulder 51 of the pulling member 5 is forcibly engaged with one of the first notch 221 or the second notch 222 of the connecting plate 22.

Preferably, formed on a bottom portion of the pulling member 5 are a first bent plate 521 and a second bent plate 522 to define the engaging gap 52 so as to provide an engaging space. The first bent plate 521 and the second bent plate 522 are provided to simplify the entire structure of the pulling member 5. In this preferred embodiment, the first bent plate 521 and the second bent plate 522 are integrally formed on the bottom portion of the pulling member 5, and each of the first bent plate 521 and the second bent plate 522 defines a roughly C-shaped section of the pulling member 5 which is relatively strong to withstand a stress exerting thereon.

The actuating cam 6 is preferably constructed from a one-piece member which is only formed with one engaging arm 61 and a cross hole (unlabeled) to simplify the entire structure. In this preferred embodiment, the engaging arm 61 of the actuating cam 6 is directly extend in or through the engaging gap 52 of the pulling member 5 so as to simplify a process for assembling the “one-piece” pulling member 5 and the “one-piece” actuating cam 6. Advantageously, no adapter member or the like is required to connect the pulling member 5 with the actuating cam 6.

The actuating cam 6 is rotatably received in the axial hole 42 of the adjustable casing 4, and is driven to rotate a predetermined angular movement by an actuating rod of a lock mechanism (not shown). Since the engaging arm 61 of the actuating cam 6 is extended in or through the engaging gap 52 of the pulling member 5 to engage therein, a rotational action of the actuating cam 6 can move a predetermined longitudinal movement of the pulling member 5. To position the angular movement of the actuating cam 6, an elastic member 62 can selectively limit one of two flat outer edges 60 of the actuating cam 6. Preferably, one distal end of the elastic member 62 is securely extended into an aperture 46 of the adjustable casing 4.

Turning now to FIGS. 1, 3 and 4, the push-button member 7 extends through the passage 44 of the adjustable casing 4 and the assembling holes 31a and 31b of the assembling plates 3a and 3b. The push-button member 7 includes a pushing rod 72 and an inclined surface 73 thereof. The inclined surface 73 of the push-button member 7 engages with a bottom edge of the pulling member 5 to cause an upward movement of the pulling member 5 in pressing the push-button member 7. In operation, after pressing the push-button member 7, the inclined surface 73 of the push-button member 7 moves the pulling member 5 upward such that the shoulder 51 of the pulling member 5 is disengaged from either of the first notch 221 or the second notch 222 of the connecting plate 22. An insertion of the inclined surface 73 of the push-button member 7 can bias the bottom edge of the pulling member 5 to move upwardly while pressing the push-button member 7. To return the pressing movement of the push-button member 7, a biasing force of a coil spring 74 is employed to return the push-button member 7. Consequently, once the press force is removed, the push-button member 7 can return to an original position. To accomplish a preferred positioning effect, the push-button member 7 further includes a protrusion member 75 selectively engaged with one of the first recessed edge 311 and the second recessed edge 312 of the first assembling hole 31a of the first assembling plate 3a. Preferably, a limit member 71 snap-connects with a distal end of the push-button member 7 to thereby prevent removing from the adjustable casing 4.

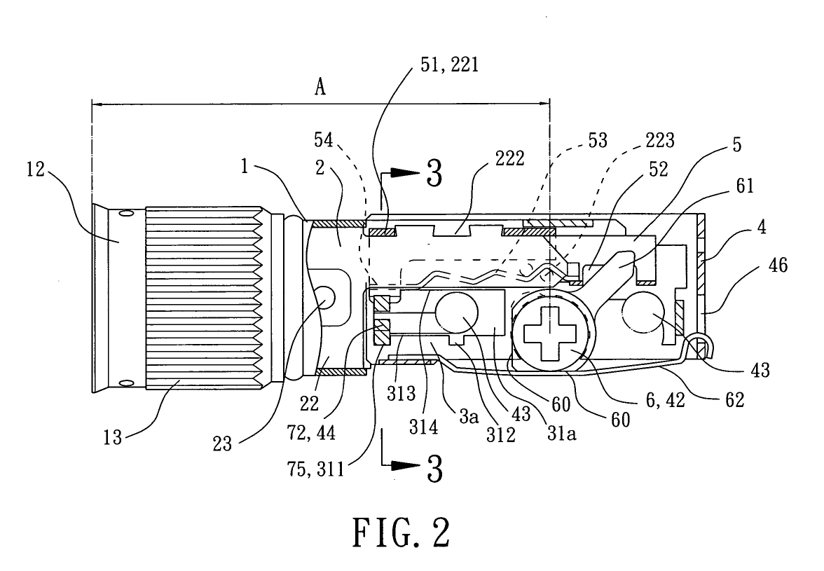

Turning now to FIG. 2, when the adjustable latch assembly is situated in a shorter assembling distance, the faceplate 12 and an axis of the actuating cam 6 is spaced a shorter distance (A). At that time, the entire deadbolt 2 is retracted in the cylindrical housing 1 and situated in the retracted position. Meanwhile, the shoulder 51 of the pulling member 5 is biased by the elastic member 53 and forcibly engaged with the first notch 221 of the connecting plate 22. Correspondingly, the engaging arm 61 of the actuating cam 5 extends into the engaging gap 52 of the pulling member 5. In a locking operation, a counterclockwise rotation of the actuating cam 6 may drive to extend the deadbolt 2 from the faceplate 12 of the cylindrical housing 1 through the pulling member 5 and the connecting plate 22.

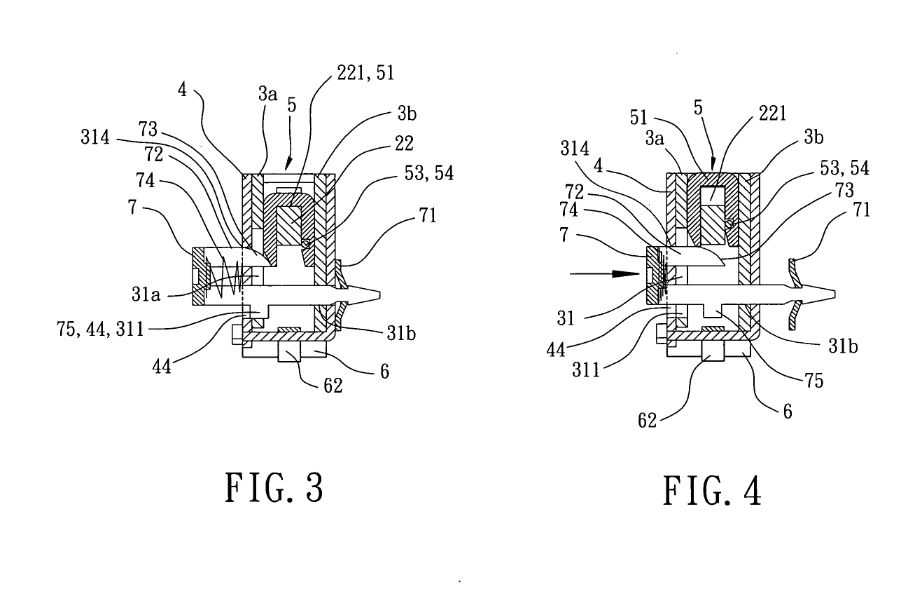

Referring back to FIG. 3, when the push-button member 7 is not yet pressed and biased by the coil spring 74, the inclined surface 73 of the push-button member 7 is unable to actuate an upward movement of the first end of the pulling member 5. Thus, the shoulder 51 of the pulling member 5 is remained in the first notch 221 of the connecting plate 22. Consequently, an adjusting movement of the adjustable casing 4 is not allowed.

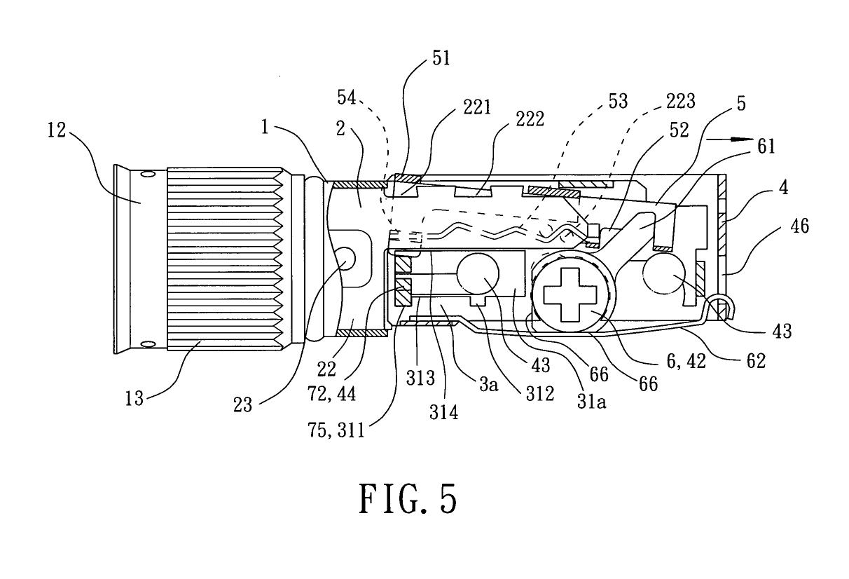

Referring back to FIG. 4, when the adjustable latch assembly is converted a smaller distance into a larger distance, the push-button member 7 must be pressed as indicated by the direction arrow in FIG. 4. The inclined surface 73 of the push-button member 7 may drive an upward movement of the first end of the pulling member 5 so that the shoulder 51 of the pulling member 5 disengages from the first notch 221 of the connecting plate 22, as best shown in FIG. 5. Consequently, an adjusting movement of the adjustable casing 4 is allowed to move away from the cylindrical housing 1 as indicated by the direction arrow in FIG. 5. However, the elastic member 53 continuously provides a bias force on the pulling member 5 such that the shoulder 51 of the pulling member 5 can be automatically engaged with the first notch 221 of the connecting plate 22 if the push-button member 7 is released. Hence, there is a need for continuously overcoming the bias force of the pulling member 5 in the adjusting operation.

In this circumstance, the push-button member 7 must be continuously pressed to maintain the engagement of the inclined surface 73 of the push-button member 7 with the bottom edge of the pulling member 5 so as to prevent the shoulder 51 of the pulling member 5 from being confined within the first notch 221 of the connecting plate 22. Accordingly, the disengagement of the shoulder 51 of the pulling member 5 from the first notch 221 of the connecting plate 22 is ensured. In the distance-adjusting operation, the protrusion member 75 of the push-button member 7 is firstly disengaged from the first recessed edge 311 of the first assembling hole 31a, and the pushing rod 72 of the push-button member 7 is guided to move a predetermined distance along the upper guiding edge 314 of the first assembling hole 31a, as best shown in FIG. 4.

The push-button member 7 can be released during the adjusting operation if the protrusion member 75 of the push-button member 7 has been released; nevertheless, the pushing rod 72 of the push-button member 7 can still move along the upper guiding edge 314 of the first assembling hole 31a, as best shown in FIG. 3. After traveling a predetermined distance, the protrusion member 75 of the push-button member 7 may be finally engaged with the second recessed edge 312 of the first assembling hole 31a.

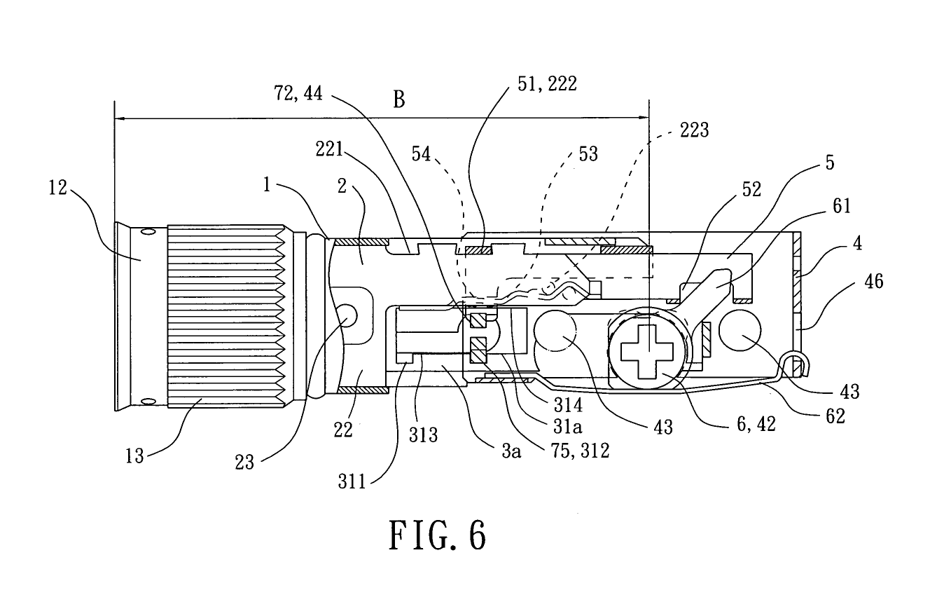

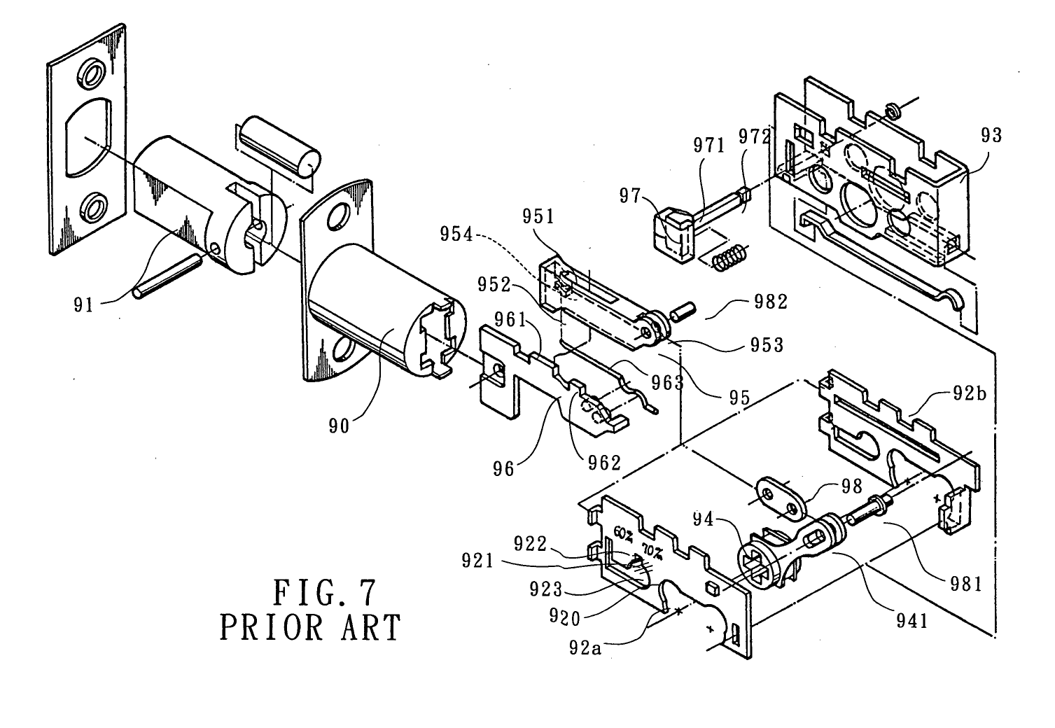

Turning now to FIG. 6, when the adjustable casing 4 is positioned, the shoulder 51 of the pulling member 5 is engaged with the second notch 222 of the connecting plate 22. Thereby, the adjustable latch assembly is situated in a greater assembling distance, and the faceplate 12 and the axis of the actuating cam 6 is spaced a greater distance (B).

Alternatively, when the adjustable latch assembly may be converted a larger distance into a smaller distance, the push-button member 7 must be pressed to disengage the shoulder 51 of the pulling member 5 from the second notch 222 of the connecting plate 22. Consequently, an adjusting movement of the adjustable casing 4 in a reverse direction is allowed. The protrusion member 75 of the push-button member 7 is disengaged from the second recessed edge 312 of the first assembling hole 31a, and the pushing rod 72 of the push-button member 7 can be guided to move in the reverse direction along the upper guiding edge 314 of the first assembling hole 31a.

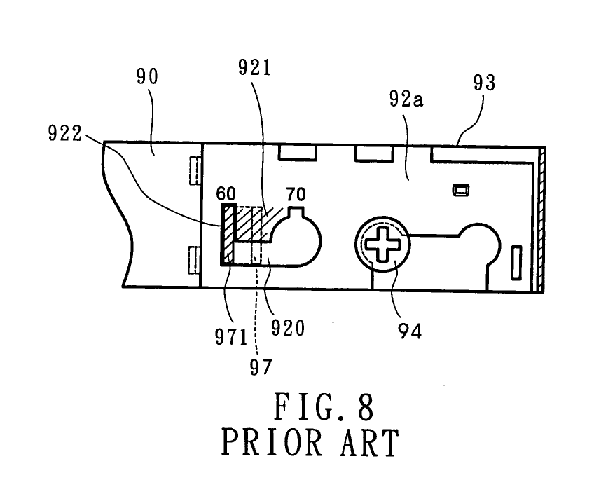

Referring back to FIGS. 1, 2, 5 and 6, at least one of the assembling plates 3 preferably includes a limiting top plate 30 to extend in horizontal. The limiting top plate covers an inner space defined between the assembling plates 3 and the adjustable casing 4 so that it can prevent the actuating cam 5 protruding from the assembling plates 3 and the adjustable casing 4 while assembling the latch assembly. Referring back to FIG. 7, the actuating cam 94, the pulling member 95 and the adapter 98 may protrude out of the adjustable casing 4 that obstructs the assembling operation on an assembling hole of a doorplate. In comparison with the present invention, the latch members of the conventional latch assembly may affect the assembling operation.

However, the adjustable latch assembly of the present invention accomplishes the direct connection of the pulling member 5 to the actuating cam 7. And the shoulder 51 of the pulling member 5 selectively engages with the first notch 221 or the second notch 222 of the connecting plate 22. Consequently, in adjusting operation, it may simplify the entire structure for speeding manufacture time and reducing manufacture cost.

With continued reference to FIG. 7, the separating wall 921 formed in the assembling hole 920 can obstruct the inclined wall 971 of the push-button member 97 if the inclined wall 971 is not completely withdrawn from the operating slot 922 of the assembling hole 920. Conversely, the adjustable latch assembly of the present invention includes the first assembling plate 3a formed with the upper guiding edge 314 in the first assembling hole 31a to guide a longitudinal movement of the push-button member 7. Advantageously, the push-button member 7 pressed in the first assembling hole 31a of the first assembling plate 3a can move along the upper guiding edge 314 of the first assembling hole 31a without the need of releasing the push-button member 7.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. An adjustable latch assembly, comprising:
a connecting plate connected with a deadbolt received in a cylindrical housing, the connecting plate including a first notch and a second notch;
a first assembling plate including a first assembling hole and a first adjusting groove, said first assembling hole being formed with an upper guiding edge which is located at an upper edge, said first assembling hole including an upper edge and a bottom edge opposite thereto, said bottom edge provided with a first recessed edge, a second recessed edge and a protruded bottom edge formed between the first recessed edge and the second recessed edge;
a second assembling plate including a second assembling hole and a second adjusting groove;
an adjustable casing arranged to receive the first assembling plate and the second assembling plate, and including an axial hole and a passage;
a pulling member constructed from an one-piece member, the pulling member including a first end having a shoulder selectively engaged with the first notch or the second notch of the connecting plate, and a second end having an engaging gap;
an actuating cam rotatably mounted in the axial hole of the adjustable casing, the actuating cam being constructed from an one-piece member formed with an engaging arm directly extended in or through the engaging gap of the pulling member or received therein to completely connect the engaging arm with the engaging gap such that the actuating cam is capable of directly actuating the pulling member which is selectively engaged with one of the first notch and the second notch of the connecting plate; and
a push-button member extended through the passage of the adjustable casing and the first assembling hole of the first assembling plate, the push-button member including an inclined surface to engage with a bottom edge of the pulling member so as to allow the shoulder of the pulling member disengaging from the first notch or the second notch of the connecting plate by means of an insertion of the inclined surface of the push-button member biasing the bottom edge of the pulling member to move upwardly while pressing the push-button member, said push-button member further including a protrusion member selectively engaged with one of the first recessed edge and the second recessed edge of the first assembling hole of the first assembling plate;
wherein, an adjusting operation, the push-button member is continuously pressed to maintain a disengagement of the shoulder of the pulling member from one of the first notch and the second notch of the connecting plate, and
wherein said push-button member is guided along said upper edge of the first assembling hole of the first assembling plate in the adjusting operation.

2. The adjustable latch assembly as defined in claim 1, wherein the pulling member includes a first bent plate and a second bent plate to define said engaging gap.

3. The adjustable latch assembly as defined in claim 2, wherein the first bent plate and the second bent plate are integrally formed on the pulling member, and each of the bent plates defines a roughly C-shaped section of the pulling member.

4. The adjustable latch assembly as defined in claim 1, wherein said upper guiding edge of the first assembling hole defines a straight line on which to guide a longitudinal movement of the push-button member.

5. The adjustable latch assembly as defined in claim 1, wherein at least one of the first assembling plate and the second assembling plate includes a limiting top plate to cover the pulling member so that the pulling member is completely received in an inner space defined between the two assembling plates and the adjustable casing.

6. The adjustable latch assembly as defined in claim 1, wherein at least one of the first assembling plate and the second assembling plate includes a longitudinal slot to receive a guide rod of the connecting plate to guide a longitudinal movement of the connecting plate.

7. The adjustable latch assembly as defined in claim 1, wherein one of the first assembling plate and the second assembling plate includes a protrusion received in a longitudinal slot of the adjustable casing to guide an adjusting movement of the adjustable casing.

8. The adjustable latch assembly as defined in claim 1, further comprising an elastic member arranged between the connecting plate and the pulling member, one end of the elastic member bias a positioning lug of the pulling member while the other end of the elastic member engaging in two limiting rods of the connecting plate, and thus the shoulder of the pulling member is forcibly engaged with one of the first notch or the second notch of the connecting plate.

9. The adjustable latch assembly as defined in claim 1, further comprising an elastic member selectively engaged with one of two flat outer edges of the actuating cam.

10. The adjustable latch assembly as defined in claim 1, further comprising a coil spring arranged between the adjustable casing and the push-button member such that the push-button member can be returned.

11. An adjustable latch assembly, comprising:
a connecting plate connected with a deadbolt received in a cylindrical housing, the connecting plate including a first notch and a second notch;
a first assembling plate connected with the cylindrical housing, and including a first assembling hole and a first adjusting groove, said first assembling hole having a bottom edge provided with a first recessed edge, a second recessed edge and a protruded bottom edge formed between the first recessed edge and the second recessed edge, said first assembling hole being further formed with an upper guiding edge which is located at an upper edge;
a second assembling plate connected with the cylindrical housing, and being arranged parallel to the first assembling plate, the second assembling plate including a second assembling hole and a second adjusting groove;
an adjustable casing arranged to receive the first assembling plate and the second assembling plate, and arranged to adjust with respect to the cylindrical housing, the adjustable casing including an axial hole and a passage;
a pulling member arranged between the first assembling plate and the second assembling plate and constructed from an one-piece member, the pulling member including a first end having a shoulder selectively engaged with the first notch or the second notch of the connecting plate, and a second end having an engaging gap, the pulling member including a first bent plate and a second bent plate being formed on a bottom portion to define said engaging gap;
an actuating cam rotatably mounted in the axial hole of the adjustable casing, the actuating cam being constructed from an one-piece member formed with an engaging arm extended in or through the engaging gap of the pulling member or received therein such that the actuating cam is capable of directly actuating the pulling member which is selectively engaged with one of the first notch and the second notch of the connecting plate; and
a push-button member extended through the passage of the adjustable casing and the first assembling hole of the first assembling plate, the push-button member including an inclined surface to engage with a bottom edge of the pulling member so as to allow the shoulder of the pulling member disengaging from the first notch or the second notch of the connecting plate;
wherein, an adjusting operation, the push-button member is continuously pressed to maintain a disengagement of the shoulder of the pulling member from one of the first notch and the second notch of the connecting plate, and
wherein said push-button member is guided along said upper edge of the first assembling hole of the first assembling plate in the adjusting operation.

12. The adjustable latch assembly as defined in claim 11, wherein the first bent plate and the second bent plate are integrally formed on the pulling member, and each of the bent plates defines a roughly C-shaped section of the pulling member.

13. The adjustable latch assembly as defined in claim 11, wherein said upper guiding edge of the first assembling hole defines a straight line on which to guide a longitudinal movement of the push-button member.

14. The adjustable latch assembly as defined in claim 11, wherein at least one of the first assembling plate and the second assembling plate includes a limiting top plate to cover the pulling member so that the pulling member is completely received in an inner space defined between the two assembling plates and the adjustable casing.

15. The adjustable latch assembly as defined in claim 11, wherein at least one of the first assembling plate and the second assembling plate includes a longitudinal slot to receive a guide rod of the connecting plate to guide a longitudinal movement of the connecting plate.

16. The adjustable latch assembly as defined in claim 11, wherein one of the first assembling plate and the second assembling plate includes a protrusion received in a longitudinal slot of the adjustable casing to guide an adjusting movement of the adjustable casing.

17. The adjustable latch assembly as defined in claim 11, further comprising an elastic member arranged between the connecting plate and the pulling member, one end of the elastic member bias a positioning lug of the pulling member while the other end of the elastic member engaging in two limiting rods of the connecting plate, and thus the shoulder of the pulling member is forcibly engaged with one of the first notch or the second notch of the connecting plate.

18. The adjustable latch assembly as defined in claim 11, further comprising an elastic member selectively engaged with one of two flat outer edges of the actuating cam.

19. The adjustable latch assembly as defined in claim 11, further comprising a coil spring arranged between the adjustable casing and the push-button member such that the push-button member can be returned.
